(19) United States
(12) Patent Application Publication
(10) Pub. No.: US 2013/0181639 A1
(43) Pub. Date: Jul. 18, 2013

(54) MOTOR DRIVE SYSTEM

(71) Applicant: DENSO CORPORATION, Kariya-city (JP)

(72) Inventors: Takahiro YAMANAKA, Kariya-city (JP); Toshihisa YAMAMOTO, Anjo-city (JP)

(73) Assignee: DENSO CORPORATION, Kariya-city (JP)

(21) Appl. No.: 13/709,326

(22) Filed: Dec. 10, 2012

(30) Foreign Application Priority Data
Jan. 13, 2012 (JP) 2012-5525

(51) Int. Cl. H02P 3/14

(52) U.S. Cl. CPC H02P 3/14
USPC 318/139

(57) ABSTRACT

A first drive circuit of a motor drive apparatus drives a motor by converting electric power of a battery. A relay is connected in high potential line between the battery and an inverter. A diode is connected in parallel to the relay. The diode conducts a current in a regeneration direction, which is from a high potential side of the inverter to a high potential electrode of the battery, under a state that the relay is in the off-state. Thus, an inductive voltage, which is generated by the motor when a reverse input torque is applied from a load side, is led to the battery through the diode, and switching elements forming the inverter are protected from the inductive voltage.

### CROSS REFERENCE TO RELATED APPLICATION

The present application relates to and incorporates herein by reference Japanese patent application No. 2012-5525 filed on Jan. 13, 2012.

### TECHNICAL FIELD

The present disclosure relates to a motor drive system, which drives a motor by converting electric power of a DC power source.

### BACKGROUND ART

A conventional motor drive system includes a drive circuit formed of a plurality of switching elements. For example, the drive circuit includes an inverter, which converts DC power into three-phase AC power to drive a three-phase AC motor. JP 2003-81099A discloses a configuration, in which two circuit breaker relays are provided in two of three power supply lines connecting output terminals of the three-phase inverter and the motor. The circuit breaker relay breaks connection between the inverter and the motor when a short-circuit failure arises in the switching element.

According to the conventional motor drive system, the motor operates as a generator and generates an induction voltage when a reverse input torque is applied from a load side to the rotation shaft of the motor. In a case that the power source side of the motor drive circuit is not connected to the power source such as a battery, the induction voltage has no place to leak. The switching elements forming the inverter receive the induction voltage and are likely to fail. The switching elements to be used need to have higher specification such as a higher withstand voltage to withstand such an induction voltage.

According to the conventional system including the two circuit breaker relays, the switching elements can be protected from the induction voltage generated by the motor by turning off the two relays in the power supply lines to thereby electrically disconnect the inverter and the motor. This configuration however requires three or more relays, which includes in addition to the two relays a power source-side relay required normally, and increases the number of component parts. The motor drive system becomes large in physical size and causes more difficulty in mounting in a vehicle.

### SUMMARY

It is an object to provide a motor drive system for protecting in simple configuration switching elements from an induction voltage, which is generated by a motor when a reverse input torque is applied under a state the motor is disconnected from a DC power source.

According to one aspect, a motor drive system comprises a DC power source, a motor, a first drive circuit, a first switching device and a unidirectional conduction element. The first drive circuit includes a plurality of switching elements and is connected to the DC power source to drive the motor by converting electric power of the DC power source. The first switching device is provided between the DC power source and the first drive circuit to electrically connect and disconnect the DC power source and the first drive circuit. The unidirectional conduction element is connected in parallel to the first switching device to allow a current to flow in a regeneration direction from a high potential side of the drive circuit to a low potential side of the first drive circuit through the DC power source and to interrupt a current to flow in a reverse direction opposite to the regeneration direction.

### BRIEF DESCRIPTION OF THE DRAWINGS

The above and other objects, features and advantage will become more apparent from the following description made with reference to the accompanying drawings. In the drawings:

FIG. 1 is a schematic circuit diagram of a motor drive system according to a first embodiment;

FIG. 2 is a schematic structural diagram of an electric power steering system using the motor drive system shown in FIG. 1;

FIG. 3 is a detailed circuit diagram of the motor drive system shown in FIG. 1;

FIG. 4 is a schematic circuit diagram a motor drive system according to a second embodiment;

FIG. 5 is a schematic circuit diagram of a motor drive system according to a third embodiment;

FIG. 6 is a schematic circuit diagram of a motor drive system according to a fourth embodiment;

FIG. 7A and FIG. 7B are partial circuit diagrams of motor drive systems according to a fifth embodiment and a sixth embodiment, respectively;

FIG. 8 is a schematic circuit diagram of a motor drive system according to a seventh embodiment;

FIG. 9 is a schematic circuit diagram of a motor drive system according to an eighth embodiment;

FIG. 10 is a schematic circuit diagram of a motor drive system according to a ninth embodiment; and

FIG. 11A, FIG. 11B, FIG. 11C and FIG. 11D are partial circuit diagrams of a motor drive system according to other embodiments.

### DETAILED DESCRIPTION OF EMBODIMENT

A motor drive system will be described with reference to embodiments, in which the motor drive system is used in an electric power steering system of a vehicle.

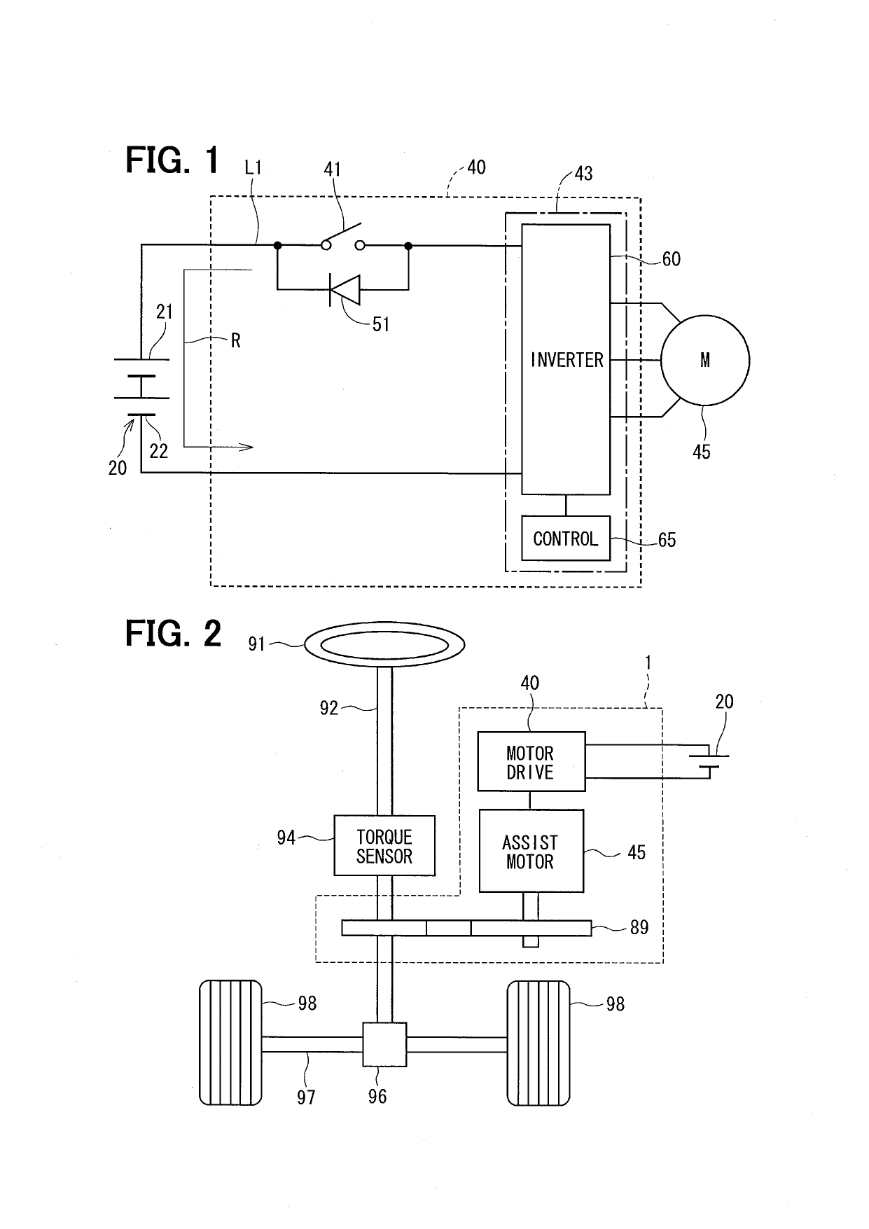

### First Embodiment A motor drive system according to a first embodiment is shown in FIG. 1 to FIG. 3.

As shown in FIG. 2, en electric power steering system 1 is provided for a steering system of a vehicle, which has a steering wheel 91 and a steering shaft 92. The power steering system 1 provides the steering shaft 92 with steering assist torque so that steering torque applied to the steering shaft 92 by a driver through the steering wheel 91 is power-assisted. The steering shaft 92 is provided with a torque sensor 94, which detects a steering torque. The steering shaft 92 is provided with a pinion gear 96 at an axial end thereof. The pinion gear 96 is meshed with a rack shaft 97. A pair of tire wheels 98 is rotatably coupled to both ends of the rack shaft 97. The rotary motion of the steering shaft 92 is converted to a linear motion of the rack shaft 97 so that the pair of tire wheels 98 is steered by an angle corresponding to the amount of linear movement of the rack shaft 97.

The electric power steering system 1 is formed of a steering assist motor 45, a reduction gear 89 and a motor drive apparatus 40. The steering assist motor 45 generates steering assist torque. The reduction gear 89 transfers the rotation output of the motor 45 to the steering shaft 92 by reducing the rotation speed. The motor drive apparatus 40 is configured to drive the motor 45. The motor drive apparatus 40 is connected to a DC battery 20 provided as a DC power source. The motor 45 is a three-phase brushless motor.

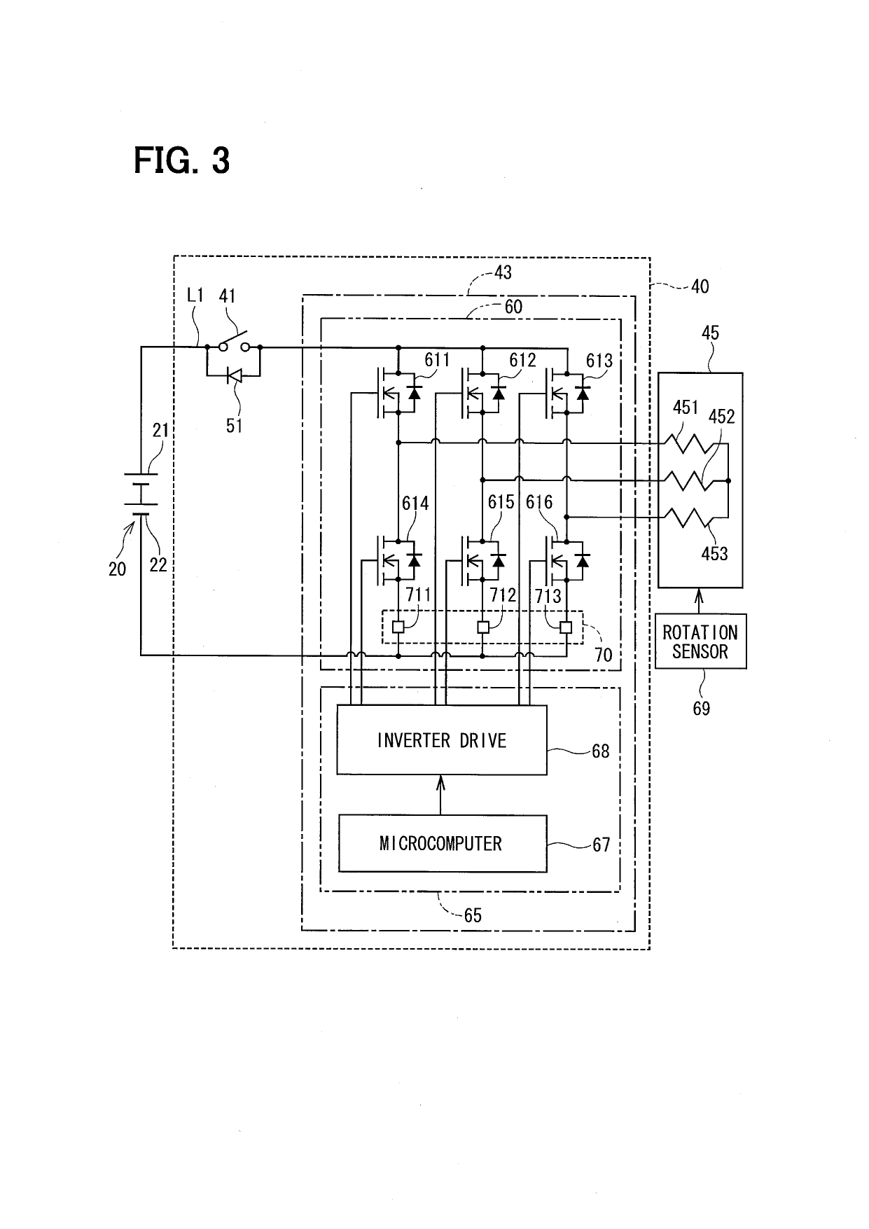

As shown in FIG. 1 and FIG. 3, the motor drive apparatus 40 includes a first drive circuit 43, a relay 41 as a first switching device, and a diode 51 as a unidirectional conduction element. The first drive circuit 43 is formed of an inverter 60 and a control circuit 65. The inverter 60 is a three-phase AC inverter, which converts DC power of the battery 20 to AC power and supplies the AC power. In the inverter 60, six switching elements 611 to 616 are connected in a bridge form. The switching elements 611 to 616 are, for example, MOSFETs (metal-oxide-semiconductor field-effect transistors).

The switching elements 611, 612 and 613 of a high potential side have drains connected to a high potential electrode 21 of the battery 20. Sources of the switching elements 611, 612 and 613 are connected to drains of the switching elements 614, 615 and 616 of a low potential side. Sources of the switching elements 614, 615 and 616 are connected a low potential electrode 22 of the battery 20 through current detection elements 711, 712 and 713. Junctions between the switching elements 611, 612, 613 and the switching elements 614, 615, 616 are connected to terminals of three-phase coils 451, 452, 453 of the motor 45, respectively. The current detection elements 711, 712 and 713 forming a current detection device 70 detects phase currents supplied to the coils 451, 452 and 453, respectively.

The control circuit 65 includes a microcomputer 67 and an inverter drive circuit 68. The microcomputer 67 performs control calculations for determining control values, which are required for motor control, based on input signals indicating a rotation angle of the motor 45 detected by a rotation angle sensor 69, a steering torque detected by the torque sensor 94, a vehicle travel speed and the like. The inverter drive circuit 68 is connected to gates of the switching elements 611 to 616 to output on/off switching control signals under control of the microcomputer 67.

The relay 41 is provided in a high potential line L1 connecting the high potential electrode 21 of the battery 20 and the high potential side of the inverter 60. The relay 41 electrically connects or disconnects the battery 20 and the inverter 60 by an on/off signal (not shown) applied thereto. The relay 41 is an electromagnetically-operated switch or any other shut-off devices, which are on/off devices. When the relay 41 is turned on, the motor 45 is supplied with power so that the steering assist torque generated by the motor 45 may be applied to the steering shaft 92. That is, the electric power steering system 1 is powered to operate. The relay 41 is turned on and off in correspondence with an ignition switch (not shown).

As long as the vehicle is at rest with its ignition switch being turned off, the relay 41 is turned off. As long as the vehicle is in operation, the relay 41 is turned on generally. The relay 41 may, however, be turned off temporarily when the vehicle hits a curbstone while traveling. If a reverse input torque is applied to the rotation shaft of the motor 45 by an external force from the load side with the relay 41 being turned off, the motor 45 operates as a generator. For example, this situation occurs when the tire wheels 98 are moved left and right at a repair shop. This situation also occurs when the tire wheels 98 are moved left and right due to an impact of collision, which is applied when the vehicle hits some fixtures such as a curbstone.

In this situation, the inductive voltage generated by the motor 45 is applied to the inverter 60 as an excessive voltage. This may cause failure of the switching elements 611 to 616. Therefore, a diode 51 is connected to the relay 41 in parallel. Under a condition that the relay 41 is turned off, the diode 51 conducts a current in a direction from the high potential side of the inverter 60 to the high potential electrode 21 of the battery 20. This direction of current flow is referred to as a regeneration direction and indicated by an arrow R in FIG. 1.

The diode 51 shuts off a current, which flows from the battery 20 to the inverter 60, that is, in a direction opposite to the regeneration direction. If the diode 51 is not provided, the inductive voltage is led to nowhere with the relay 41 being turned off. It is therefore unavoidable that the switching elements 611 to 616 of the inverter 60 is subjected to the excessive voltage. The switching elements 611 to 616 thus need be set to have high specification such as high withstand voltage so that the switching elements 611 to 616 are protected from breakage.

However, the inductive voltage can be led to the battery 20 through the diode 51, which is connected in parallel to the relay 41, even when the relay 41 is in the off-state. It is thus possible to prevent the excessive voltage from being applied to the switching elements 611 to 616 of the inverter 60 and avoid the switching elements 611 to 616 from failing. That is, the switching elements 611 to 616 can be protected from the inductive voltage. It is thus not necessary to set the specification of the switching elements 611 to 616 to be higher than that normally required.

According to the conventional system described above, at least two circuit breaker relays need be provided at the motor side to protect the switching elements from the inductive voltage in addition to the power source side relay, which need be provided in any system. Thus three or more relays are needed. According to the first embodiment, the switching elements 611 to 616 can be protected from the switching elements 611 to 616 by only simply connecting the diode 51 in parallel to one relay 41. Thus the number of component parts of the motor drive apparatus 40 can be reduced in comparison to the conventional system. As a consequence, the motor drive apparatus 40 can be reduced in size and its mountability in the electric power steering system 1 and the like can be improved.

### Second, Third and Fourth Embodiments

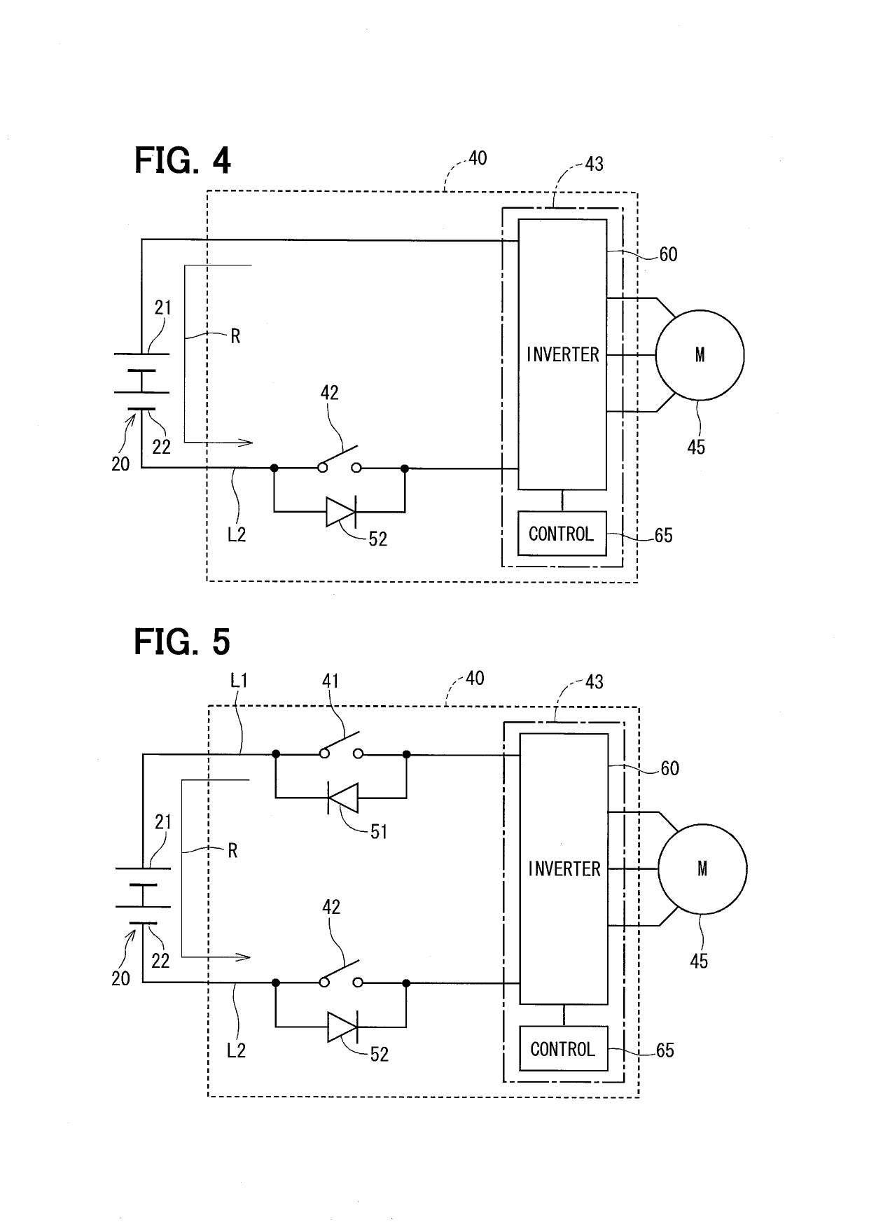

A motor drive system according to a second embodiment to a fourth embodiment are shown in FIG. 4 to FIG. 6. Those embodiments are different from the first embodiment in respect of the arrangement and number of relays. In the following description of the embodiments, substantially same component parts are designated by the same reference numerals thereby to simplify the description.

According the second embodiment shown in FIG. 4, a relay 42 is provided as a first switching device in a low potential line L2 between the low potential electrode 22 of the battery 20 and the low potential side of the inverter 60. A diode 52 is connected as a unidirectional conduction element in parallel to the relay 42. The diode 52 is provided to conduct the current in a direction from the low potential electrode 22 of the battery 20 to the low potential side of the inverter 60, that is, in the same regeneration direction as in the first embodiment, and shuts off the current, which flows in the direction opposite to the regeneration direction. Similarly to the first embodiment, failure of the switching elements caused by the inductive voltage of the motor 45 can be avoided.

According to the third embodiment shown in FIG. 5, the relay 41 and the diode 51 are provided in the high potential line L1 as in the first embodiment and the relay 42 and the diode 52 are provided in the low potential line L2 as in the second embodiment.

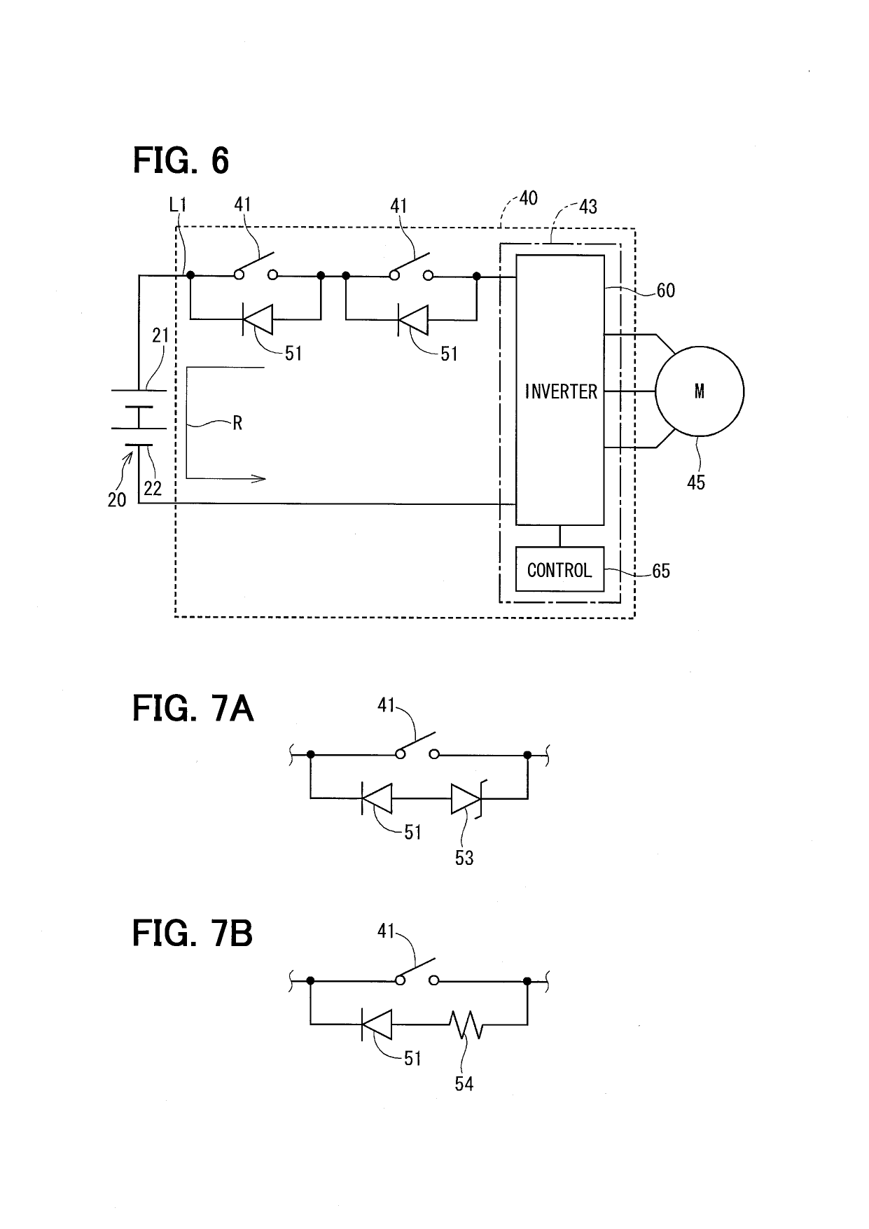

According to the fourth embodiment shown in FIG. 6, two sets of the relay 41 and the diode 51 are connected in series in the high potential line L1. The relay 41 and the diode 51 in each set is provided in the similar manner as in the first embodiment.

According to the second to the fourth embodiments, since two relays are provided as the first switching devices, the reliability is improved further. These relays are also effective to prevent erroneous operation. Even though two relays are provided, the number of relays can be reduced in comparison to the conventional system described above, in which three or more relays are required.

### Fifth and Sixth Embodiments

A motor drive system according to a fifth embodiment and a sixth embodiment are shown in FIG. 7A and FIG. 7B, respectively. In these embodiments, a unidirectional conduction element is further added to the apparatuses of the first embodiment to the fourth embodiment.

According to the fifth embodiment shown in FIG. 7A, a Zener diode 53 is connected in series with the diode 51, which is provided as the unidirectional conduction element. The inductive voltage is led to the battery 20 through the Zener diode 53 and the diode 51 only when the induction voltage exceeds a threshold voltage of the Zener diode 53. The threshold voltage of the Zener diode 53 is set to a voltage, which will not cause influence to the switching elements 611 to 616. According to the sixth embodiment shown in FIG. 7B, a resistor 54 is connected in series with the diode 51, which is provided as the unidirectional conduction element. The resistance value of the resistor 54 is set in correspondence to a current, which flows when the inductive voltage is applied. It is possible to connect both Zener diode 53 and resistor 54 in series with the diode 51.

The regeneration current, which flows when the induction voltage is led to the battery 20 through the unidirectional conduction element, flows oppositely to the current, which flows from the battery 20 to the motor 45 in the normal motor driving operation. When the motor 45 generates the induction voltage, a braking torque arises in the motor 45 to oppose the normal operation. When the braking torque arises, a vehicle driver will sense that the steering wheel 91 is heavily loaded.

According to the fifth and the sixth embodiments, therefore, the braking torque is nullified or reduced in a range, in which the switching elements 611 to 616 are not influenced. According to the fifth embodiment, the braking torque is prevented when the induction voltage is lower than a predetermined level. According to the sixth embodiment, the braking torque is reduced uniformly over an entire voltage range.

It is assumed here, for example, that a vehicle hits a curbstone while traveling and the tire wheels 98 vibrates in the left-right direction. In this case, the relay 41 is turned off and the braking torque is generally generated by the inductive voltage in the motor 45.

According to the fifth or the sixth embodiment, the braking torque can be prevented from generating or reduced.

### Seventh, Eighth and Ninth Embodiments

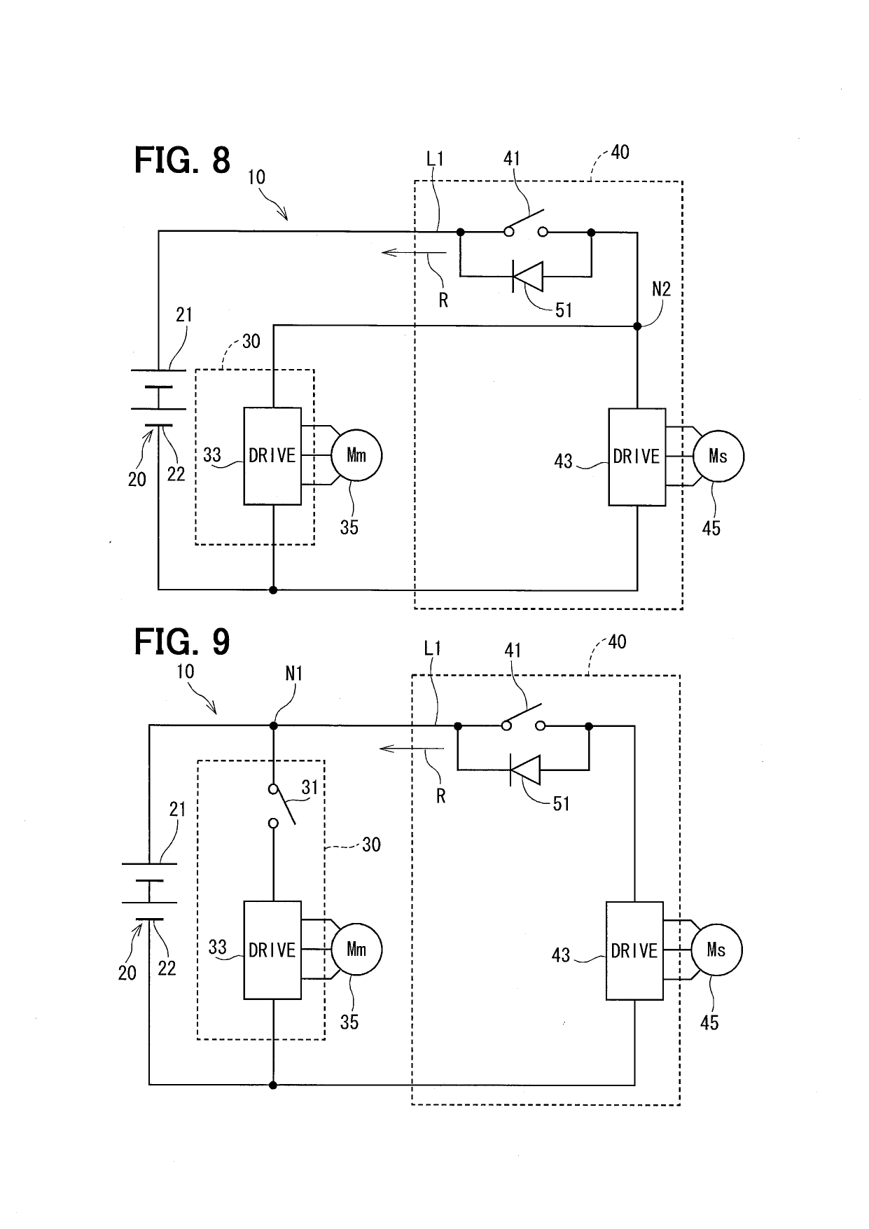

A motor drive system according to a seventh embodiment to a ninth embodiment is shown in FIG. 8 to FIG. 10. The motor drive system in the seventh embodiment to the ninth embodiment is configured as an in-vehicle power supply system 10, which includes a motor drive apparatus 30 for a main motor 35 for driving a vehicle in addition to the motor drive apparatus 40 for the steering assist motor 45. The main motor 35 consumes more power to drive the vehicle than that consumed by the steering assist motor 45. The battery 20 is therefore a high voltage type, which is provided as a main motor battery to output a high voltage required by the main motor 35.

As shown in FIG. 8 to FIG. 10, the motor drive system includes the first drive circuit 43 for driving the steering assist motor 45 and a second drive circuit 33 for driving the main motor 35 are connected in parallel to the battery 20. In FIG. 8 to FIG. 10, the main motor 35 and the steering assist motor 45 are distinguished from each other by character symbols Mm and Ms, respectively.

As shown in FIG. 8, the second drive circuit 33 drives the main motor 35, which drives an electric vehicle or a hybrid vehicle. The second drive circuit 33 is formed of a power converter such as an inverter and a control circuit similarly to the first drive circuit 43. A battery of 288 V, for example, is used as the battery 20 for supplying electric power to the second drive circuit 33. The second drive circuit 33 is connected in parallel to the first drive circuit 43 at a node N2, which is between the first drive circuit 43 and the relay 41. That is, the relay 41 supplies or shuts off power in common to both the first drive circuit 43 and the second drive circuit 33.

In a case that the first drive circuit 43 for the steering assist motor 45 is connected to a battery provided exclusively, a battery of about 14 V is generally used. As far as the battery voltage is about this output level, it is less likely that the switching elements will be damaged even when an inductive voltage is generated. In a case that the first drive circuit 43 shares the battery 20 of about 288 V, a plurality of batteries mounted in a vehicle can be consolidated. However, the load applied to the switching elements at the time of generation of the inductive voltage becomes excessive and increases probability of failure. The first embodiment to the sixth embodiment are therefore so configured that the motor drive apparatus 40 has the unidirectional conduction element 51 connected in parallel to the first switching device 41. It is thus remarkably advantageous in that the inductive voltage can be led to the battery 20 to avoid failure of the switching elements.

Even in a case that only the motor drive apparatus 40 is connected to the battery 20 as in the first embodiment to the sixth embodiment, the operation and advantage become effective as the voltage of the battery 20 is higher than the withstand voltage level of the switching elements.

According to the eighth embodiment shown in FIG. 9, a series circuit of the main motor relay 31 and the second drive circuit 33 is connected to a series circuit of the relay 41 and the first drive circuit 43 in parallel at a node N1, which is between the relay 41 and the battery 20. The main motor relay 31 is referred to as a second switching device.

In this case, power supply to the first drive circuit 43 and power supply to the second drive circuit 33 are conducted or shut off independently of each other by the relay 41 and the relay 31.

When the excessive current flows to the second drive circuit 33 due to the short-circuit failure or the grounding failure in the second drive circuit 33, the main motor relay 31 turns off but the relay 41 remains in the on-state. Thus the power supply to the first drive circuit 43 is continued. As a result, a driver is enabled to drive a vehicle to a shoulder of a road by turning the steering wheel 91 while using the assist torque provided by the steering assist motor 45 even under a state that the main motor 35 is not driven.

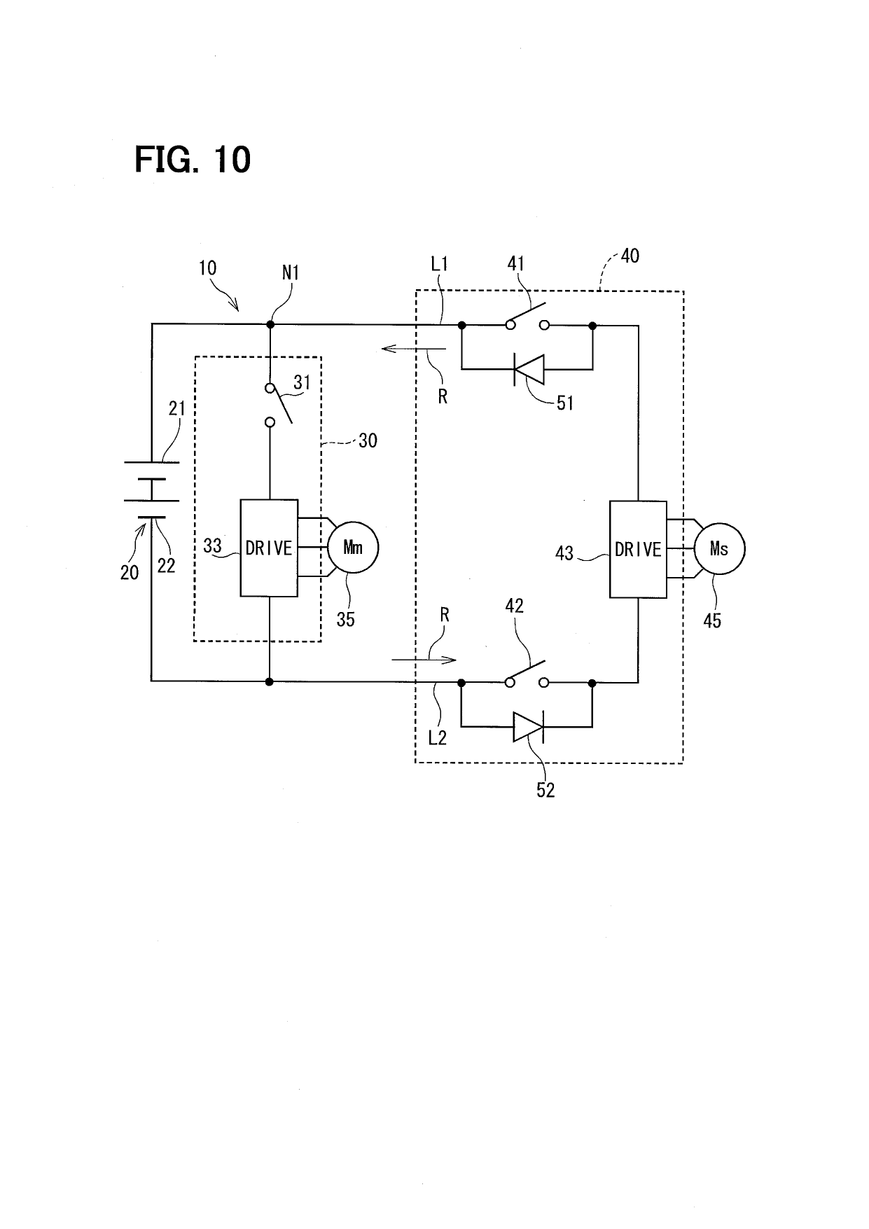

According to the ninth embodiment shown in FIG. 10, contrary to the eighth embodiment, the motor drive apparatus 40 is configured as in the third embodiment. That is, two relays 41 are provided in the high potential line L1 and the low potential line L2. Thus the reliability is further improved.

### Other Embodiments

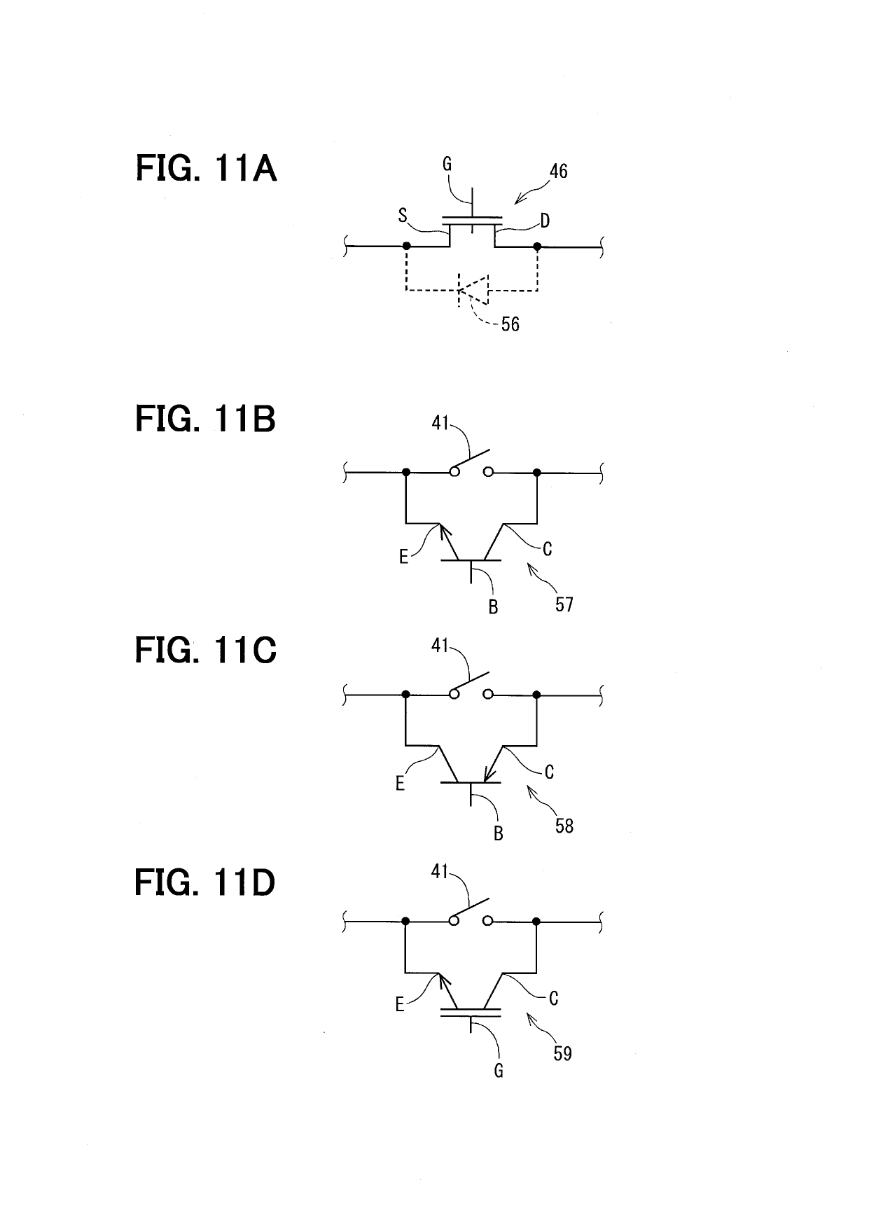

The unidirectional conduction element is not limited to the above-described element (diode) but may be other elements exemplified in FIG. 11A to FIG. 11D. That is, the first switching device may be formed of a MOSFET 46 and a parasitic diode 56 of the MSOFET 46 may be used as the unidirectional conduction element as shown in FIG. 11A. Alternatively, a PNP transistor 57, a PNP transistor 58 and an IGBT 59 may be connected in parallel to the relay 41 as shown in FIG. 11B, FIG. 11C and FIG. 11D, respectively. It is noted that alphabetical symbols G, S, D, B, E and C in FIG. 11A to FIG. 11D designate a gate, a source, a drain, a base, an emitter and a collector, respectively.

The motor drive system described above is not limited to a system, which drives a three-phase brushless motor. For example, the system may include a DC/DC converter in place of the inverter and drive a DC motor with brushes. Application of the motor is not limited to a steering assist motor but may be any other motor, which is likely to generate the inductive voltage in response to the reverse input torque applied from the load side.

In the seventh embodiment to the ninth embodiment, the in-vehicle power supply system is configured to include the first drive circuit 43 for driving the steering assist motor 45 and the second drive circuit 33 for driving the main motor 35 are connected to the battery 20 in parallel. In addition, a variety of auxiliary motors, which as a brake motor, a power window motor, air-conditioner blower motor, a wiper motor and the like may be connected to the battery 20.

What is claimed is:

1. A motor drive system comprising:
a DC power source having a high potential electrode and a low potential electrode;
a motor;
a first drive circuit including a plurality of switching elements and connected to the DC power source to drive the motor by converting electric power of the DC power source;
a first switching device provided between the DC power source and the first drive circuit to electrically connect and disconnect the DC power source and the first drive circuit; and
a unidirectional conduction element connected in parallel to the first switching device to allow a current to flow in a regeneration direction from a high potential side of the drive circuit to a low potential side of the first drive circuit through the DC power source and to interrupt a current to flow in a reverse direction opposite to the regeneration direction.

2. The motor drive system according to claim 1, wherein:
the first switching device and the unidirectional conduction element are provided between the high potential electrode of the DC power source and the high potential side of the first drive circuit and between the low potential electrode of the DC power source and the low potential side of the first drive circuit.

3. The motor drive system according to claim 1, further comprising:
a Zener diode connected in series with the unidirectional conduction element in a parallel relation to the first switching device.

4. The motor drive system according to claim 1, further comprising:
a resistor connected in series with the unidirectional conduction element in a parallel relation to the first switching device.

5. The motor drive system according to claim 1, wherein:
the motor is a steering assist motor in an electric power steering system; and
the DC power source is a battery, which outputs a voltage higher than a voltage normally required to drive the steering assist motor.

6. The motor drive system according to claim 5, further comprising:
a main motor provided to drive a vehicle by consuming more power than a power consumed by the steering assist motor;
a second drive circuit provided in parallel to the first drive circuit relative to the battery.

7. The motor drive system according to claim 6, further comprising:
a second switching device provided to electrically connect and disconnect the battery and the second drive circuit,
wherein the second switching device is connected in series with the second drive circuit in a parallel relation to the first switching device.

8. The motor drive system according to claim 2, wherein:
the motor is a steering assist motor in an electric power steering system; and
the DC power source is a battery, which outputs a voltage higher than a voltage normally required to drive the steering assist motor.

9. The motor drive system according to claim 8, further comprising:
a main motor provided to drive a vehicle by consuming more power than a power consumed by the steering assist motor;
a second drive circuit provided in parallel to the first drive circuit relative to the battery.

10. The motor drive system according to claim 9, further comprising:
a second switching device provided to electrically connect and disconnect the battery and the second drive circuit,
wherein the second switching device is connected in series with the second drive circuit in a parallel relation to the first switching device.
